(19) United States
(12) Patent Application Publication
(10) Pub. No.: US 2003/0066244 A1
(43) Pub. Date: Apr. 10, 2003

(54) Reconfigurable clamp assembly

(76) Inventors: Brian H. Staser, Rochester Hills, MI (US); Mark A. Vickery, Tecumseh (CA); Fred L. Sawgle, Lapeer, MI (US)

Correspondence Address: Kathryn A. Marra, Delphi Technologies, Inc., P.O. Box 5052, Troy, MI, 48007-5052, US

(21) Appl. No.: 10/068,102

(22) Filed: Feb. 5, 2002

Related U.S. Application Data
(60) Provisional application No. 60/327,404, filed on Oct. 5, 2001.

(51) Int. Cl. E05F 11/38

(52) U.S. Cl. 49/375; 49/372; 49/352; 49/349; 49/348

(57) ABSTRACT

An automotive door is equipped with a window regulator for raising and lowering a window glass. The window regulator includes reconfigurable bracket assemblies that are mirror images of each other. Each bracket assembly includes a base plate that has a guide block for attaching the bracket assembly to a guide member of the automotive window regulator, and a clamp plate that is attached to the base plate in a first position with respect to the clamp plate or in a second position with respect to the clamp plate. The base plate is symmetrical with respect to an imaginary lateral centerline whereby a first bracket assembly may be configured by attaching the clamp plate to the base plate in the first position or a second bracket assembly may be produced by attaching the clamp plate to the base plate in the second position, the second clamp plate being a mirror image of the first bracket assembly.

### RELATED APPLICATION

This patent application claims benefit of U.S. Provisional patent application 60/327,404 filed Oct. 5, 2001.

### FIELD OF INVENTION

This invention relates to a clamp assembly and more particularly to a clamp assembly for an automotive window regulator that raises and lowers a windowglass in a vehicle door.

### BACKGROUND OF THE INVENTION

U.S. Pat. No. 5,309,678 granted to Tadashi Adachi May 10, 1994 discloses a schematic general construction of a power window device for a vehicle door in FIG. 4 of the patent. A window glass of the door is slideably supported at its forward and back ends by doorframe portions, which are arranged along the vertical direction of the door. A bracket that is secured to the lower end portion of the window glass slides on a vertical guide rail that is fixed to the vehicle door. The bracket is secured to a tape that is trained over three rollers so as to run in a triangular loop. The three rollers include two guide rollers at the upper and lower ends of the guide rail and a third drive roller that is between the two guide rollers in the vertical direction and spaced form the guide rollers in the horizontal direction. The drive roller, which is driven by an electric motor, drives the tape, which in turn raises and lowers the window glass. In an alternate arrangement shown in FIG. 3 of the patent, the lower guide roller is driven eliminating the need for a third roller.

Typically the bracket is assymetrical with respect to the guide rail that the bracket slides on as shown in FIG. 4 of the patent. This means that the brackets for the right hand and left hand doors have different right hand and left hand shapes, respectively. Thus window regulator systems typically require at least two different brackets for attaching window glass to the guide member.

The Adachi '678 patent discloses a “single channel” window regulator in which the window glass is transported by one bracket that travels on one guide member, in this particular instance a guide rail. The U.S. Pat. No. 4,607,456 granted to Daiichi Shiraishi et al Aug. 26, 1986 discloses a dual channel window regulator system in which forward and rearward brackets are attached to the lower end of the window glass. The forward and rearward brackets slide on forward and rearward guide members respectively. The forward bracket shown in FIG. 10 of the '456 patent is different from the rearward bracket that is shown in FIG. 18. This is the typical situation. Thus dual channel window regulator systems typically require four different brackets that are attached to the window glass to the guide channels.

### SUMMARY OF THE INVENTION

The invention provides a reconfigurable bracket assembly for attachment to the lower end portion of a window glass that can be configured to provide either of two bracket assemblies that are mirror images of each other for single channel window regulator on either the driver or the passenger side of the vehicle respectively. The reconfigurable bracket assembly can also be configured to provide either a forward and/or a rearward bracket assembly for a dual channel regulators on either side of the vehicle.

The reconfigurable bracket assembly of the invention also preferably supports the window glass and clamps onto the bottom portion of the window glass without any need for holes in the bottom portion of the window glass. The reconfigurable bracket assembly also preferably includes a clamp base that has dual function tabs that locate a cooperating clamp member as well as support the bottom portion of the window glass. The reconfigurable bracket assembly is also preferably shaped to enhance a lever clamping action and preferably also includes an elastomeric isolator for the window glass.

### BRIEF DESCRIPTION OF THE DRAWINGS

FIG. 1 is a forward view of a driver side door, schematic in nature, showing a power window regulator having a bracket assembly of the invention;

FIG. 2 is a forward view of a rearward guide rail that is part of the power window regulator that is shown in FIG. 1;

FIG. 3 is a perspective view of the rearward guide rail and a rearward bracket assembly of the invention for the driver side door that is shown in FIG. 1.

FIG. 4 is an enlarged forward view of the rearward bracket assembly that is shown in FIG. 3;

FIG. 5 is a section view of the rearward bracket assembly taken substantially along the line 5-5 of FIG. 4 looking in the direction of the arrows;

FIG. 6 is a rearward view of the rearward bracket assembly that is shown in FIG. 4,

FIG. 7 is a partial top view of the rearward bracket assembly that is shown in FIG. 4;

FIG. 8 is a forward view of the components of the rearward bracket assembly that is shown in FIG. 4 with the components repositioned and reassembled to provide a forward bracket assembly for the driver side door that is shown in FIG. 1; and

FIG. 9 is a partial top view of the forward bracket assembly that is shown in FIG. 8.

### DETAILED DESCRIPTION OF PREFERRED EMBODIMENT

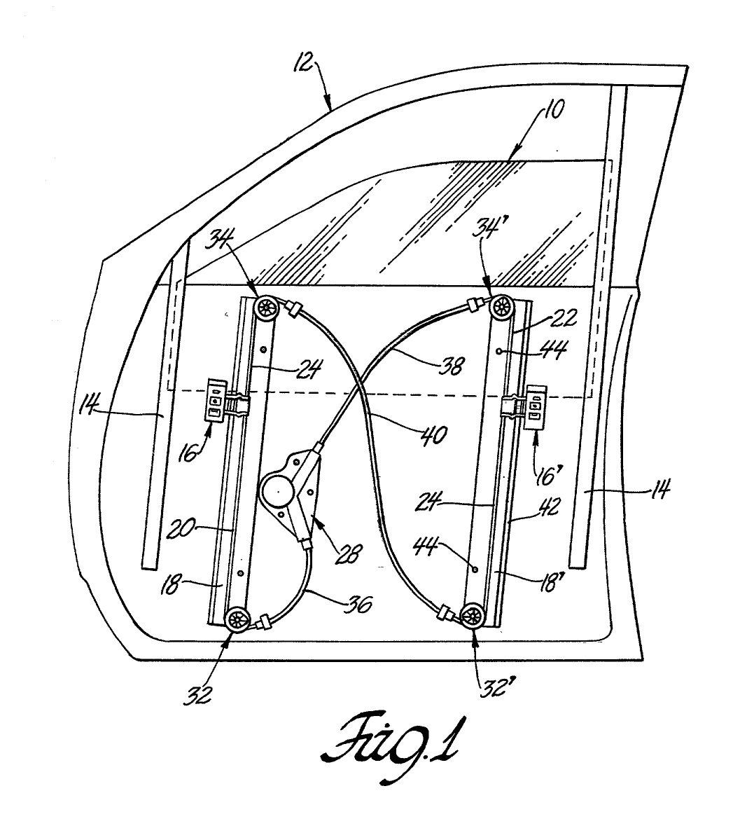

Referring now to FIG. 1, a window glass 10 of an automotive door 12 is slideably supported at its forward and back ends by guides 14. Window glass 10 is raised and lowered by a window regulator 15 that includes forward and rearward bracket assemblies 16, 16′ that are secured to the lower end of the window glass 10. Bracket assemblies 16, 16′ run respectively on vertical guide rails 18, 18′ that are supported by the automotive door. Bracket assemblies 16, 16′ are moved vertically on guide rails 18, 18′ by cables 20, 22 and 24 that are moved by a cable drum that rotates in a cable drum housing 28. The cable drum is rotated by a crank handle or by an electric motor (not shown). The ends of cables 20 and 22 are attached to cable drum 28 so that one cable is wound onto the cable drum while the other cable is simultaneously payed off (wound off) the cable drum with the cable being wound depending upon the rotation of the cable drum. Such cable drums are well know and need not be described in detail.

Cable 20 wraps around a lower roller assembly 32 at the lower end of forward guide rail 18 and then is attached to forward bracket assembly 16 so as to pull down on bracket assembly 16 when the cable drum is rotated in one direction. On the other hand, cable 22 wraps around an upper roller assembly 34′ at the upper end of rearward guide rail 18′ so as to pull up on rearward bracket assembly 16′ when the cable drum is rotated in the opposite direction. The third cable 24 connects the forward bracket assembly 16 to the rearward bracket assembly 16′ and is trained over an upper roller assembly 34 at the upper end of forward guide rail 18 and a lower roller assembly 32′ at the lower end of rearward guide rail 18′ so that forward bracket assembly 16 pulls rearward bracket assembly 16′ down when forward bracket assembly 16 is pulled down and rearward bracket assembly 16′ pulls forward bracket assembly 16 up when rearward bracket assembly 16′ is pulled up. Cables 20, 22 and 24 are preferably kept in tension. One way to tension cables 20, 22 and 24 is to provide cable jackets or conduits 36, 38 and 40 that are spring biased at each end away from the associated cables. This is a well known technique and need not be described in detail.

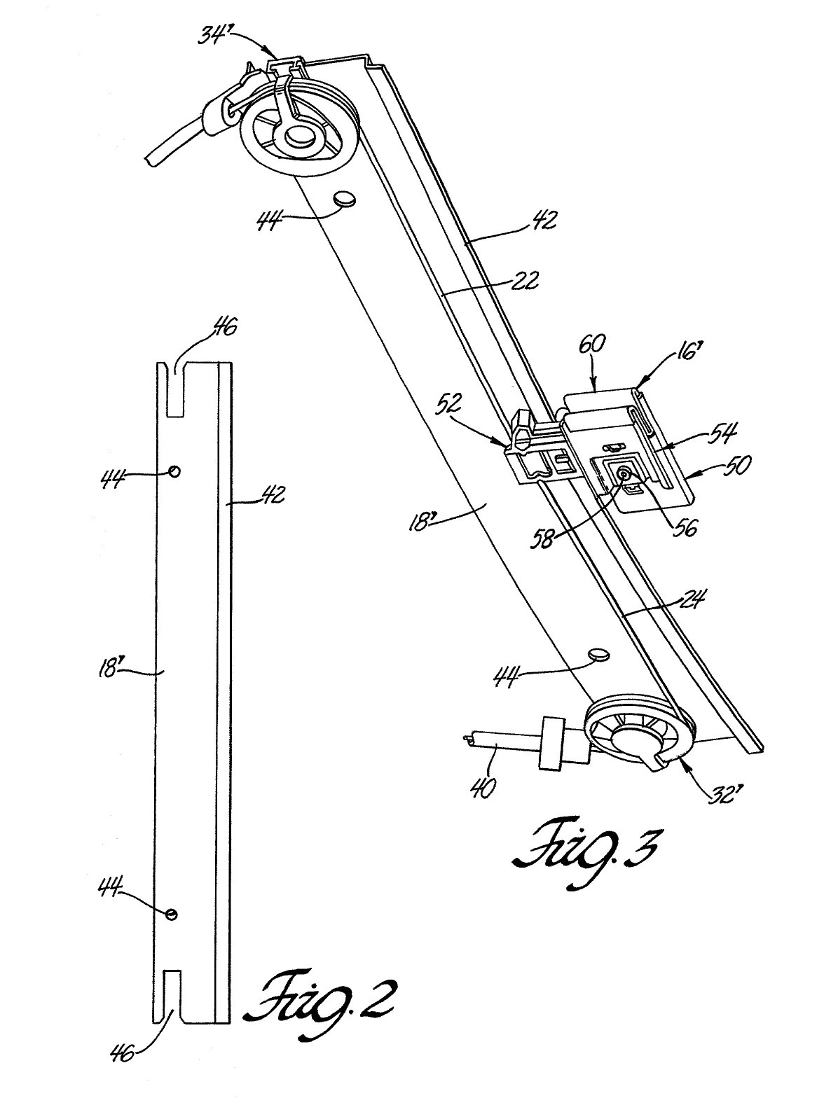

FIG. 2 shows the rearward guide rail 18′ that comprises a rolled section that has a flange 42, L-shaped in cross section, along one edge for attaching bracket assembly 16′ to the guide rail and two holes 44 for attaching the guide rail to a vehicle door. Guide rail 18′ also has open ended, vertical slots 46 in each end for attaching the respective upper and lower roller assemblies 34′ and 32′ respectively as best shown in FIG. 3. Roller assemblies 32′ and 34′ are described in detail in copending patent application Ser. No. ______ filed ______ (Attorney docket DP-306417) which is incorporated herein by reference. However, roller assemblies 32′ and 34′ need not be described in detail to understand the invention which is directed to the bracket assemblies 16 and 16′.

As indicated above, this invention concerns the bracket assembly 16′. Bracket assembly 16′ comprises a base plate 50, a guide block 52, a clamp plate 54 having a cinch nut 56, a fastener 58 and an isolator 60.

Base plate 50 is a sheet metal stamping comprising a rectangular body 62 with an integral, depressed, laterally extending support arm 64 as best shown in FIG. 8. Rectangular body 62 has flanged side edges for increased rigidity and a central raised embossment 66. Two perpendicular, vertically spaced tabs 68 are integrally connected to the respective upper and lower edges of embossment 66. Tabs 68 each have a hole 70 at the juncture with embossment 66 and embossment 66 has a central hole 72. Upper and lower lips 73 are formed by slitting rectangular body 62 and depressing portions of rectangular body 62 between the slits and the respective edges of body 62. Arm 64 has a raised dome 74 that creates a dimple in the back side. Base plate 50 is symmetrical with respect to an imaginary lateral centerline 78 that intersects the center of hole 72. This symmetry is an important feature of the invention because the base plate 50 can be oriented with the arm 64 extending forwardly as shown in FIG. 4 or rotated 180 degrees in the plane of the drawing to the position shown in FIG. 8 where the arm 64 extends rearwardly.

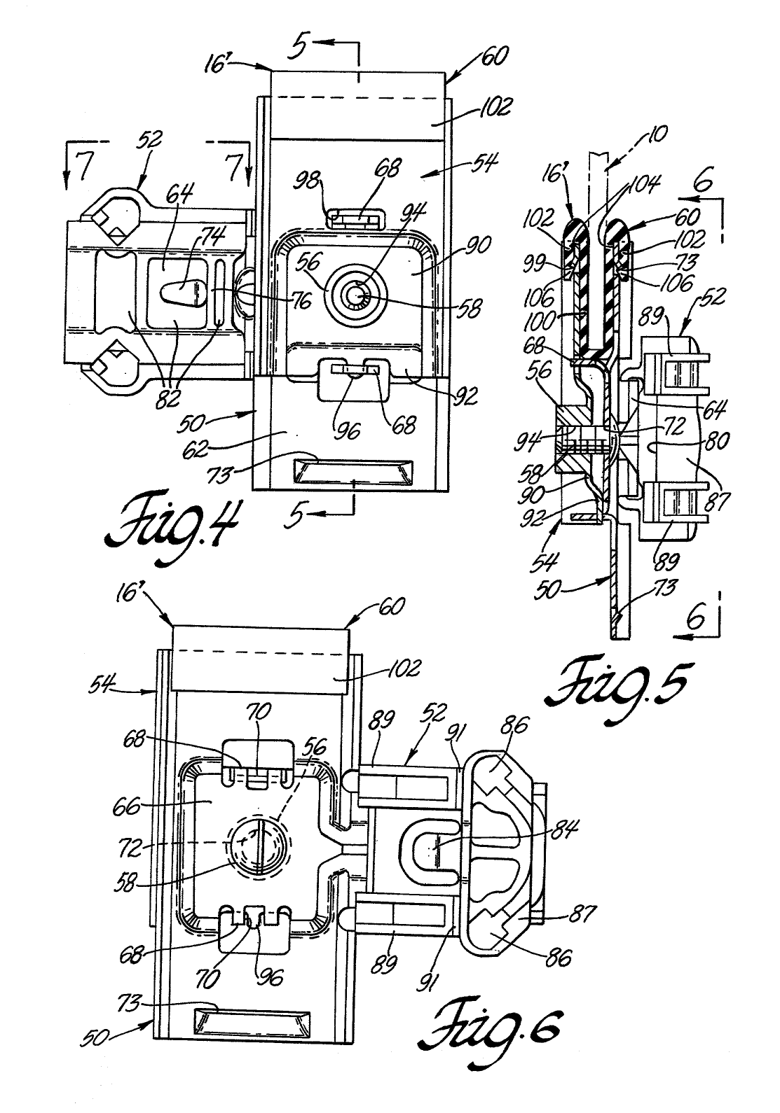

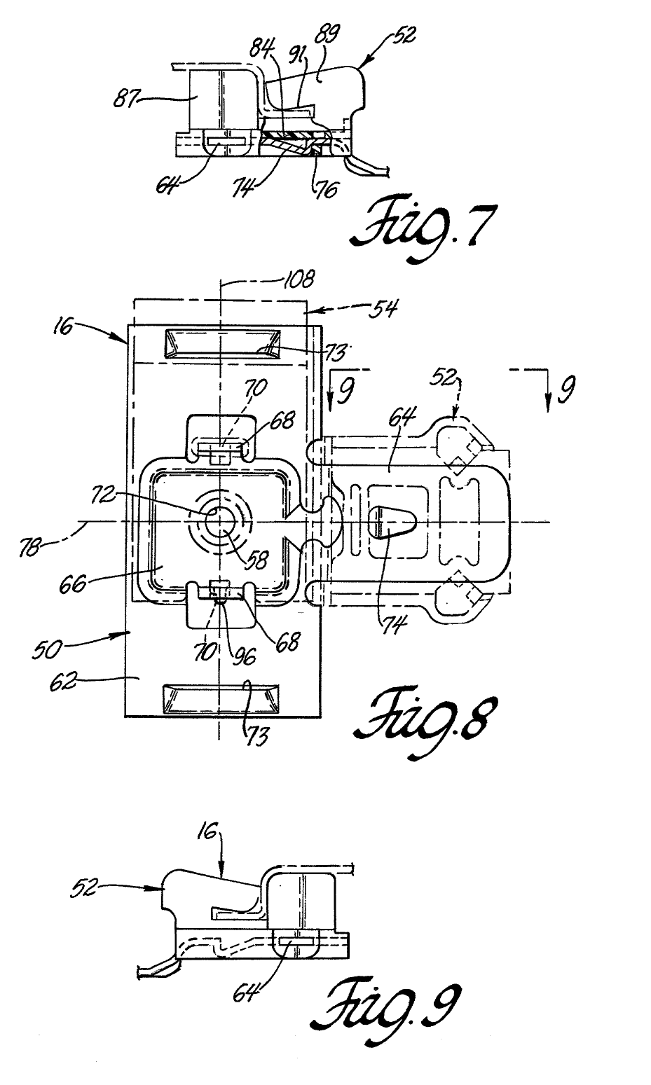

Referring now to FIGS. 4-7, guide block 52 is a molded plastic body that has a longitudinal slot 80 extending through it. Slot 80 receives arm 64 to attach guide block 52 to base plate 50. The front side of guide block 52 has several windows 82 that communicate with slot 80 to reduce weight and save material. The center window receives dome 74 behind strap 76 to retain guide block 52 on arm 64 as best shown in FIG. 4. Guide block 52 is further retained on arm 64 by a cantilevered arm 84 of the guide block arm that is below slot 80. Arm 84 engages a surface of tab 64 and biases guide block 52 down against the opposite surface of tab 64 in the vicinity of dome 74. Latch arm 84 has a nib that extends into dimple 76 as best shown in FIGS. 6 and 7. Guide block 52 also has two cavities with communicating cable slots that form cable end retainers 86 in a bulkhead 87 of the guide block. Bulkhead 87 cooperates with integral ears 89 of the guide block to form to L-shaped slots 91 as best shown in FIGS. 6 and 7. L-shaped slots 91 receive flange 42 of rear-guide rail 18′ whereby rear bracket assembly 16′ is slideably mounted on rear guide rail 18′.

Clamp plate 54 is a sheet metal stamping of generally rectangular shape with flanged sides for increased rigidity. Clamp plate 54 includes a lower embossment 90 that has a raised step 92 at the lower end. Embossment 90 has a central hole 94 and the raised step 92 has a central locator tab 96. Clamp plate includes a slot 98 above embossment 90 and an upper lip 99 that is formed by a slit as in the case of base plate 50. The threaded cinch nut 56 is secured in central hole 94.

Bracket assembly 16′ includes a threaded fastener 58 that cooperates with cinch nut 56 to clamp bracket assembly 16′ onto the lower end portion of window glass 10. Isolator 60 isolates the metal parts of bracket assembly 16′ from window glass 10.

Isolator 60 is molded of elastomeric material and comprises a generally U-shaped body 100 with flaps 102 at each free end. Flaps 102 form slots 104 that receive the upper ends of base plate 50 and clamp plate 54 respectively. The free ends of flaps 102 have nibs 106 that engage lips 73 and 99 respectively to retain isolator 60. The bottom of isolator 60 rests on the upper tab 68 of base plate 50. The upper and lower tabs 68 are used to locate clamp plate 54 as explained below.

The rearward bracket assembly 16′ shown in FIGS. 4, 5, 6 and 7 is assembled in the following manner. Base plate 50 is oriented with embossment 66 facing up and support arm 64 extending forward as shown in FIG. 4. Clamp plate 54 is placed on top of the upper portion of base plate 50 so that the lower step 92 of embossment 90 engages embossment 66, the central tab 96 engages in hole 70 of lower support tab 68 and upper support tab 68 engages in slot 98. Holes 70 in tabs 68 are sized and located such that tab 96 of clamp plate 54 cannot fit into the hole 70 of the lower positioned tab 68 if clamp plate 54 is inverted, that is, with embossment 90 and step 92 facing up. The upper positioned tab 68 also cannot fit into slot 98. Thus support tabs 68, slot 98 and locator tab 96 on lower step 92 locate clamp plate 54 on base plate 50 and also prevent misassembly of clamp plate 54 to base plate 50.

After clamp plate 54 is placed on base plate 50, fastener 58 is then screwed into cinch nut 56 to hold base plate 50 and clamp plate 54 together. Clamp plate 54 now acts as a lever with raised step 92 being as a fulcrum and fastener 58 applying a force to clamp plate 54 to clamp the window glass 10 between plates 50 and 54.

Isolator 60 is then assembled to plates 50 and 54 inserting the upper ends of plates 50 and 54 into slots 104 until the body 100 of isolator 60 bottoms on the upper support tab 68 and nibs 106 at the lower ends of flaps 102 engage lips 73 and 99 to retain isolator 60.

Guide block 52 may be assembled to base plate 54 at any time during the assembly process by inserting support arm 64 into slot 80 until support arm 64 is retained by dome 74 and latch arm 84. The guide block 52 of rearward assembly bracket 16′ is then slid onto the rear guide rail 18′. The bottom portion of window glass 10 is then inserted into the U-shaped body 100 of isolator 60 until it pushes the bottom of body 100 down against the upper support tab 68. Fastener 58 is then screwed further into cinch nut 56 until the bottom portion of window glass 10 is firmly clamped between base plate 50 and clamp plate 54.

The forward bracket assembly 16, which is a mirror image of the rearward bracket assembly 16′, is assembled from identical parts. However, base plate 50 is rotated 180 degrees in the plane of the paper so that support arm 64 faces rearward when embossment 66 faces up as shown in FIG. 8. Clamp plate 54, fastener 58, isolator 60 and guide block 52 are then assembled to base plate 50 in the same manner as described above. The assembled bracket assembly 16 is then attached to the forward guide rail 18 and the bottom portion of window glass 10 in the same manner as in the case of the rearward bracket assembly 16′.

The rearward bracket assembly for the passenger door (not shown) is identical to the forward bracket assembly 16. However, the forward bracket assembly 16 is rotated 180 degrees around the imaginary vertical centerline 108 of base plate 50 when the rearward bracket assembly for the passenger door is assembled to the guide rail and window glass of the passenger door. The forward bracket assembly for the passenger door (not shown) is identical to the rearward bracket assembly 16′. However the rearward bracket assembly 16′ is also rotated 180 degrees about the vertical centerline 108 for assembly into the passenger door.

Thus the forward and rearward bracket assemblies 16 and 16′ are made from identical parts by reconfiguring the bracket assemblies as described above. Furthermore, the rearward bracket assemblies on opposite sides of the car are made from identical parts by reconfiguring and reorienting the bracket assemblies. This also applies to the forward bracket assemblies. In other words, the forward and rearward bracket assemblies provide the bracket assemblies 16 and 16′ for the passenger door by using the rearward bracket assembly 16′ as the forward bracket assembly for the passenger door and the forward bracket assembly 16 for the rearward bracket assembly for the passenger door. Hence all four bracket assemblies are made from identical parts which reduces manufacturing cost significantly.

While a preferred embodiment is disclosed, a worker in this art would understand that various modifications would come within the scope of the invention. Thus, the following claims should be studied to determine the true scope and content of this invention.

We claim:

1. A reconfigurable bracket assembly for an automotive window regular or the like, comprising:
a base plate having a guide block for attaching the bracket assembly to a guide member of the automotive window regulator,
a clamp plate that is attachable to the base plate in a first position with respect to the clamp plate or in a second position with respect to the clamp plate,
the clamp plate being attached to the base plate in either the first position or the second position, and
the base plate having an imaginary lateral centerline and being symmetrical with respect to the imaginary lateral centerline whereby a first bracket assembly may be configured by attaching the clamp plate to the base plate in the first position or a second bracket assembly may be configured by attaching the clamp plate to the base plate in the second position, the second clamp plate being a mirror image of the first bracket assembly.

2. The reconfigurable bracket assembly as defined in claim 1 wherein the base plate has a lateral arm and the guide block is attached to the lateral arm.

3. The reconfigurable bracket assembly as defined in claim 1 wherein the clamp plate has a raised step that engages the base plate to provide a fulcrum for clamping the base plate and the clamp plate against opposite sides of a window glass.

4. The reconfigurable bracket assembly as defined in claim 1 wherein the base plate has first and second tabs that locate the clamp plate with respect to the base plate.

5. The reconfigurable bracket assembly as defined in claim 1 further comprising a isolator of elastomeric material having a U-shaped body that is disposed between the base plate and the clamp plate.

6. A reconfigurable bracket assembly for an automotive window regular or the like, comprising:
a base plate having a guide block for attaching the bracket assembly to a guide member of the automotive window regulator,
a clamp plate that is attachable to the base plate in a first position with respect to the clamp plate or in a second position with respect to the clamp plate,
the clamp plate being attached to the base plate in either the first position or the second position,
the base plate having first and second tabs that locate the clamp plate in either the first position or the second position,
one of the tabs being a support for a window glass when the window glass is disposed between the base plate and the clamp plate, and
the base plate having an imaginary lateral centerline and being symmetrical with respect to the imaginary lateral centerline whereby a first bracket assembly may be configured by attaching the clamp plate to the base plate in the first position or a second bracket assembly may be configured by attaching the clamp plate to the base plate in the second position, the second clamp plate being a mirror image of the first bracket assembly.

7. The reconfigurable bracket assembly as defined in claim 6 further comprising a isolator of elastomeric material having a U-shaped body that is disposed between the base plate and the clamp plate and supported on the one of the tabs.

8. The reconfigurable bracket assembly as defined in claim 6 wherein the base plate has a lateral arm and the guide block is attached to the lateral arm.

9. The reconfigurable bracket assembly as defined in claim 6 wherein the clamp plate has a raised step that engages the base plate to provide a fulcrum for clamping the base plate and the clamp plate against opposite sides of a window glass.

10. A reconfigurable bracket assembly for an automotive window regular or the like, comprising:
a base plate having a guide block for attaching the bracket assembly to a guide member of the automotive window regulator,
a clamp plate that is attachable to the base plate in a first position with respect to the clamp plate or in a second position with respect to the clamp plate,
the clamp plate being attached to the base plate in either the first position or the second position and having a raised step that engages the base plate to provide a fulcrum for clamping the base plate and the clamp plate against opposite sides of a window glass,
a fastener that attaches the clamp plate to the base plate at a location spaced from the raised step so that the fastener applies a clamping force to the clamp plate, and
the base plate having an imaginary lateral centerline and being symmetrical with respect to the imaginary lateral centerline whereby a first bracket assembly may be configured produced by attaching the clamp plate to the base plate in the first position or a second bracket assembly may be configured by attaching the clamp plate to the base plate in the second position, the second clamp plate being a mirror image of the first bracket assembly.

11. The reconfigurable bracket assembly as defined in claim 10 wherein the base plate has a lateral arm and the guide block is attached to the lateral arm.

12. The reconfigurable bracket assembly as defined in claim 10 wherein the base plate has first and second tabs that locate the clamp plate with respect to the base plate.

13. The reconfigurable bracket assembly as defined in claim 11 further comprising a isolator of elastomeric material having a U-shaped body that is disposed between the base plate and the clamp plate and supported by one of the first and the second tabs.
